(19) United States
(12) Patent Application Publication
(10) Pub. No.: US 2010/0294996 A1
(43) Pub. Date: Nov. 25, 2010

(54) MATERIAL FOR THE FORMATION OF STRUCTURES HAVING A SUPPORT FUNCTION

(76) Inventor: Holger Redtel, Perleberg (DE)

Correspondence Address: KRIEGSMAN & KRIEGSMAN, 30 TURNPIKE ROAD, SUITE 9, SOUTHBOROUGH, MA, 01772, US

(21) Appl. No.: 12/450,381

(22) PCT Filed: Mar. 20, 2008
(86) PCT No.: PCT/EP2008/053435

§ 371 Date: Mar. 17, 2010

(30) Foreign Application Priority Data
Mar. 23, 2007 (DE) 102007014938.9

(51) Int. Cl. H01B 1/12; C08F 6/00

(52) U.S. Cl. 252/500; 528/480

(57) ABSTRACT

The invention describes a material for the formation of structures consisting of a polymer or a polymer mixture and an initiator, wherein the polymer or polymer mixture can be transformed from a liquid or viscous state to a solid state by the initiator, and the use of said material as well as a method for the production of structures using said material.

The invention relates to a material for the formation of structures and a method for the production of a structure as well as the use of the material.

Needed in many areas of life are items that are bulky or can be transported poorly. Also, it is often necessary to convey devices required at a location where, due to their large size, they cannot be brought in or can be brought in only in a disassembled state.

Materials with energy-absorbing function are known in the prior art. Mentioned here by way of example are inserts in auto seats, such as described in U.S. Pat. No. 6,688,686 B1, for example, or gel inserts in devices for the stabilization of decubitus patients, such as described in EP 0 057 838 A1, for example. On the other hand, devices are needed for use in the transport of fragile, bulky, or larger objects, also under disaster conditions. For example, complex transport means are described for the transport of persons in U.S. Pat. No. 5,121,514, in U.S. Pat. No. 5,560,059, in U.S. Pat. No. 6,898,811 B2, in U.S. Pat. No. 7,281,285 B2, in US 2008/0001421 A1, in FR 2,602,971, or in JP 10248950 A. Described in GB 2,401,055 A is a film for diverse use in aiding survival under adverse conditions, said film being placed into an apparatus through which it can be employed in a number of uses as, for example, a rescue device, a sleeping bag, a blanket, a stretcher, a water reservoir, a tent, a shelter wall, or a poncho. This film is fastened in place for the respective purpose by use of specific fasteners, but does not undergo any targeted change in its characteristics through the action of energy.

On the other hand, materials that absorb energy are known. Described in U.S. Pat. No. 7,091,297 B2, for example, are thermoplastic polyurethanes that have an alternating sequence of hard and soft segments with an integrated oligomeric silesquioxane diol as chain lengthener as well as diisocyanates and have these characteristics. Shape memory polyurethanes with one hard segment and at least two soft segments are described in U.S. Pat. No. 6,720,402 B2, for example.

Described in DE 100 16 486 C2 is a variable-length patient rescue and support system having modular, intrinsically rigid elements, which can be combined in variable number by mutual attachment. Disclosed in U.S. Pat. No. 6,539,566 B1 is a patient rescue and support system with radius arms on either side. The arms support an upper frame via cross tubes and linear actuators act on the cross tubes to move the upper frame horizontally or vertically. Described in DE 197 08 394 A1 is a device for the transport of patients, which has intrinsically rigid or rigidifiable supports with detachable parts.

Hitherto, however, no devices have been disclosed that are both simple to handle and easy to transport and that can be introduced in the required form at the site of use without mechanical devices, such as hinges, eyelets, or belts. Hitherto, in the prior art, no special materials have been employed that make superfluous the incorporation of hinges, belts, or similar mechanical means.

Therefore, the problem of the invention is to make available a material that is easy to transport and can be introduced in the required form at the site of use.

The problem of the present invention is solved by a material for the formation of structures, wherein a polymer or a polymer mixture can be transformed by an initiator from a liquid or viscous state to a solid state.

The material according to the invention, which has an energy-absorbing and/or shape memory structure, can be easily transported to the site of application, where, through application, it is reversibly brought to a form that is suitable for the respective application by the action of energy in the form of heat, force, or work, it remains in this form during the application, and, if need be, it returns to the original form after the application.

The material according to the invention is a system that is self-fastening through the action of energy or through work. The material according to the invention consists of one or more polymers, whose chemical structure and the morphology based on it are designed in such a way that, under the action of energy, they change their elastic or viscoelastic state by at least a power of ten in modulus when the external conditions are changed to a relatively small degree. Within short state changes of the external conditions, this change leads to major jumps in characteristics, through which the characteristics of the device are changed crucially in the desired sense.

The change in the state of the polymer or of the polymer mixture is preferably reversible. Such a material makes possible the production of support devices having an energy-absorbing function. In the process, the material according to the invention is changed in its characteristics in a targeted manner, through heat, external forces, or fluids to which it is exposed, this change being reversible when the external factors cease to act.

The initiator is preferably suited for transferring energy in the form of heat, force, and/or work to the polymer or the polymer mixture. The forms of energy that can be used for changing the characteristics are, on the one hand, heat energy, that is, a cooling or heating of the material in the device by 0.5 to 10 K, and, on the other hand, pressure in the range of 1 to 100,000 P, which brings about a deformation and, as a result, an internal heating of the material through changes in structure, such as, for example, changes in the crystal or domain structure, or an expansion, through which, once again, a thermal change in state occurs in the material, or a change in the relative humidity of the ambient atmosphere, by means of which the material becomes more elastic on account of, for example, a plasticizer effect, and, as a result, attains a lower modulus, or else by immersion in liquids, the diffusion of which into the surface of the material according to the invention also leads to changes in structure and, through these jumps, to changes in the mechanical characteristics. Furthermore, the energy can be supplied in the form of work, with the work being transformed to heat in the materials by way of the special structure thereof and this heat, in turn, bringing about morphological structural changes and thus changes in characteristics.

A combination of two or more of these energy or environmental forms to produce the desired energy-absorbing or shape memory effect is also a subject of this invention. Thus, for example, pressure and temperature, combined together, can act on the device or the material according to the invention. Furthermore, a combination of temperature and a change due to the surrounding medium—in an aqueous solution, for example—is possible. A combination of such physical factors or influences brings about the change in state of the polymer or polymer mixture according to the invention and thus of the material according to the invention.

The polymer is preferably a polyolefin, such as polyethylene or polypropylene, a polystyrene or a copolymer of polystyrene with acrylonitrile and/or butadiene, a polyurethane (PU), a copolymer of ethane, a polyvinyl alcohol, a polyvinylbutyral (PVB), an ethylene-propylene-diene copolymer (EPDM), a silicone, a polyether, a polyester, or a mixture of these polymers.

Coming into consideration for the applications described here are essentially polymers, composites, or composite materials. Such materials have, in essence, a compact structure and, due to their structure, are capable of absorbing energy, transforming it to heat, or storing or transforming work through energy cycles. Materials of the kind described may consist of polyolefins, such as polyethylene or polypropylene, of polystyrene or the copolymers thereof with acrylonitrile and/or butadiene (ABS, SBS, SAN), or of polyurethanes.

Coming into consideration as polymers or polymer mixtures for use in the material according to the invention are polyurethanes, cross-linked ethylene-propylene-diene copolymers (EPDM), silicones, or polyether esters. The selection of suitable polymers or polymer mixtures is made according to the intended use, with attention being paid to not only the type of polymer or polymer mixture but also its suitability either as energy-absorbing material or as shape memory polymer or as a combination of both.

In particular, the following polymers or polymer mixtures are employed according to the invention.

Employed as polyurethanes are
a) those based on at least two polyether alcohols of different molecular weight, of which at least one of the polyether alcohols is trifunctional with respect to hydroxyl groups and has a molecular weight of at most 1000 and the second polyether alcohol has a hydroxyl functionality of 2 to 3 and a molecular weight of at least 2000, with this mixture being allowed to react with a di- and/or trifunctional isocyanate at an isocyanate index of 45 to 115 in the presence, if necessary, of catalysts and/or additives,
b) those based on polyether alcohol mixtures containing in them dispersed nanoscale and/or microscale oligo- and/or polyureas, which are obtained by depolymerization of polyurethane soft foams, obtained by reaction with one or more di- and/or trifunctional isocyanates at an isocyanate index of 55 to 155 in the presence, if necessary, of catalysts and/or additives or
c) those based on polyether alcohol—polyester alcohol mixtures, in which the polyether alcohols have a hydroxyl functionality of 2 to 3 and a molecular weight of 2000 to 7000 and the polyester alcohols have a hydroxyl functionality of 2 to 2.3 and a molecular weight of 250 to 650, this mixture being allowed to react with one or more di- and/or trifunctional isocyanates at an isocyanate index of 55 to 115 in the presence, if necessary, of catalysts and/or additives.

However, other combinations of starting materials are also conceivable if they have the characteristics defined according to the invention, that is, if they absorb energy, have a shape memory, and/or exhibit a modulus jump of at least one power of ten upon slight change from the outside—for example, a temperature change of 3 to 8 K.

Understood and employed as polymers or polymer mixtures according to the present invention are also materials that are allowed to react by reaction extrusion of polymers containing reactive groups and hence reactive monomers, oligomers, polymers, and/or catalysts. Selected from this group of materials are
d) copolymers of ethylene with side-position carbon-carbon double bonds, which undergo radical cross-linkage by use of peroxides, nitrogen eliminators, etc. during the extrusion,
e) copolymers of ethylene with side-position carbon-carbon double bonds, which are cross linked by reactive monomers, such as silanes or amines,
f) copolymers of ethylene with side-position functional groups, which can undergo reaction with groups capable of reacting with them to form monomers, oligomers, or polymers,
g) polyvinyl alcohols with side-position hydroxyl groups and hydroxyl indices of between 50 and 400 mg KOH/g, which are allowed to react with di- and/or polyisocyanates and/or isocyanate prepolymers,
h) polyvinyl butyrals with side-position hydroxyl groups and hydroxyl indices of between 5 and 300 mg KOH/g, which are allowed to react with di- and/or polyisocyanates and/or isocyanate prepolymers,
i) polyether esters with end-position hydroxyl groups and hydroxyl indices of between 1 and 30 mg KOH/g, which are allowed to react with di- and/or polyisocyanates and/or isocyanate prepolymers,
j) polyurethanes based on polycaprolactone polyols with a molecular weight of 2000 to 10,000, which are allowed to react with one or more di- and/or polyisocyanates,
k) polyvinyl butyrals with side-position hydroxyl groups and hydroxyl indices of between 5 and 300 mg KOH/g, which are allowed to react with isocyanate prepolymers based on polyether alcohol mixtures containing nanoscale fillers dispersed in them,
l) polyvinyl butyrals with side-position hydroxyl groups and hydroxyl indices of between 5 and 300 mg KOH/g, which are allowed to react with isocyanate prepolymers based on polyether alcohol mixtures containing nanoscale or microscale oligo- and/or polyureas dispersed in them.

Given an appropriate composition of the starting materials and processing, the polymers and polymer mixtures mentioned here have the characteristics that are to be achieved. However, this presentation of the polymers or polymer mixtures does not exhaust whatsoever the group of energy-absorbing polymers. Therefore, polymers or polymer mixtures different from those mentioned here may also be employed in the material according to the invention.

The polymers or polymer mixtures employed can be changed in terms of their elastic behavior within a short time, that is, within one second to five minutes, to their present form in a targeted manner. Elastic behavior is understood here to mean a property that is characterized by an elasticity modulus of 100 to 12,000 N/mm² and a Shore hardness of between A25 and D50.

The production of the polymers or polymer mixtures for use in the material according to the invention takes place by extrusion, injection molding, casting, blowing, reaction extrusion, or reaction injection molding to form strips, wires, profiles, moldings, flat structures, composites, or compound structures made up of one or more of the polymers or polymer mixtures mentioned. Following production, they can be joined further to one another or to other polymers or polymer mixtures, for example, by braiding, twisting, weaving, adhesive attachment, or welding. Furthermore, composites can be produced by fusing or coating. In another form, 2 to 100 wires, profiles, or tubes are combined to form bundles and, if need be, employed inside a covering, so that fibrous or tubular bundles are created, which are employed in the material according to the invention.

Contained in a preferred embodiment of the invention are one or more fillers.

The filler is preferably selected as a filler taken from the group of electrical conductors, thermally conducting substances, hydrophilic substances, and nanoscale inorganic or organic substances.

Conceivable is the addition of specific fillers that are incorporated into the polymer or polymer mixture and that are intended to enhance these effect. Thus, electrical conductors, such as, for example, wires, may be incorporated into the polymer or polymer mixture and, when a voltage is applied, these conductors lead to local heating, which results in a change in state. Furthermore, special electrically conducting fillers, such as, for example, iodine or metal powder or iodized activated carbon, can be incorporated into the entire material or else into a layer of a composite material and this layer then conducts the required thermal energy to the composite, so that the latter changes its viscoelastic characteristics in an abrupt manner.

Further conceivable is an addition of thermally conducting fillers that are incorporated into the polymer or the polymer mixture and lead to an improved heat transfer by way of external heat sources and to a fast and complete heating throughout the material. It is possible to employ, for example, silicon carbide, boron carbide, aluminum nitride, or similar substances as such fillers.

It is further conceivable to incorporate hydrophilic fillers or hydrophilic regions or structural segments into the polymer or polymer mixture or to build them into the polymer structure. As such fillers, it is possible to use, for example, starches, cellulose, low-molecular-weight polyvinyl alcohol, polyethylene glycols, etc. When longer segments made up of polyethylene glycol units having a molecular weight of 200 to 5000 are incorporated, good results can be obtained in the design of the polymer structure.

Also conceivable is the incorporation of nanoscale inorganic or organic fillers into the polymer or polymer mixture to enhance the energy-absorbing effect or the shape memory effect. Preferred as nanoscale inorganic fillers are montmorillonite, magnesium, silicon carbide, alkaline-earth metal sols, and/or layer silicates. Included as nanoscale organic fillers are inactive and active fillers. Used as inactive nanoscale fillers are, for example, polymers obtained from dispersions and incorporated into the polymer or polymer mixture, such as polystyrene, styrene copolymers like SAN (thermoplastic copolymers made up of styrene and acrylonitrile), or SBS (styrene/butadiene/styrene triblock copolymers). Employed as active organic fillers are specially produced oligo- or polyureas having functional groups on the particle surface.

In a preferred embodiment of the invention, the polymer or polymer mixture is enclosed by a covering, with the covering imparting the form to the structure. To this end, the material according to the invention can be placed in a covering. This covering can have, beyond a binding function, also a shaping function; that is, during their production, the polymers are already incorporated into the covering and remain in it, so that a composite is produced.

Furthermore, this covering can be adapted to the conditions of use or the particular application. Used in this case are those covering materials that are stable toward the polymer or polymer mixture and cannot penetrate through the covering. The covering materials in this case may have a wall thickness of 0.01 to 10 mm and be made up of identical polymer or different polymers, such as, for example, PVC, polyacrylates, PTFE, PVDF, polypropylene, polystyrene, ethylene-vinyl acetate copolymers, of metals such as steel, stainless steel, bronze, aluminum, aluminum alloys, magnesium, or magnesium alloys, or of inorganic substances such as ceramics, silicates, or glass. For flat materials, it is possible to employ plastic films, such as, for example, polyethylene, polypropylene, ethylene-vinyl acetate copolymer, polyvinylidene fluoride, polyvinylidene chloride, polystyrene, or polyester films.

The situation at the site of use can be exploited to trigger the change in characteristics according to the invention. Thus, for example, a high atmospheric humidity at the site of use can be utilized such that the material becomes softer and, as a result, attains a lower hardness and higher elasticity. In the case of cold surroundings, the change in characteristics should come about at lower temperature, this being achieved by way of the structure of the material, for example, by lower cross-linking density, by higher molecular weights, or by lower indices during reactions. Conversely, for use at higher temperatures in the tropics or in the desert, for example, it holds that the effect according to the invention will be triggered at higher temperatures, for example, by an increase in the cross-linking density, shorter structures, or more rigid structural elements.

Through the applied energy acting from the outside, it is possible to trigger structural changes in the polymer or polymer mixture. Such structural changes may consist, for example, in a change in the crystal structure or in a change in the space group of the crystals. Furthermore, it is possible to shift the phase boundaries in the case of phase-separated polymers through reorganization of intermolecular bonds and thereby to create a higher or lower degree of phase separation or more clearly or more poorly defined phase boundaries (domain boundaries). In the case of certain polymers or polymer mixtures, it is also possible to trigger reactions in them, by means of which a change in the molecular weight distribution occurs—for example, through transesterifications in polyester mixtures or in polyether esters.

Furthermore, the problem of the present invention is solved by a method in which the polymer or the polymer mixture is transformed from a liquid or viscous state to a solid state by activation of the initiator. In this case, a use of different polymers or polymer mixtures may be dictated by the surroundings at the site of use with respect to, for example, temperature, humidity, altitude, etc. The polymers may also be selected from the polymers and polymer mixtures given above. In addition, it is also possible to add the above-mentioned fillers. The activation of the initiator in this case takes place by supplying a force in the form of a temperature change or work.

In a preferred embodiment of the invention, one or more fillers are incorporated into the polymer or polymer mixture.

The filler is preferably selected from the group of electrical conductors, thermally conducting substances, hydrophilic substances, and nanoscale inorganic or organic substances.

In another preferred embodiment of the invention, the polymer or the polymer mixture is introduced into a covering, and the covering provides the shape of the structure to be formed. The covering should be made of one of the materials described above and should be matched to the respective use. In this case, the covering is constructed in such a way that, through actuation of the initiator and change in the polymer or polymer mixture associated therewith, the latter is transformed to the desired structure.

The energy transfer in this case can be induced, as described above, by an initiator.

Furthermore, the problem of the present invention is solved by a use of the device for the production of devices in medicine, in medical technology, in construction, in advertisement, in the armaments industry, in disaster response, in sports (sports and recreation articles), in motor vehicle manufacture, in space technology, in the food industry, or in tool production.

The use of the material according to the invention is possible in almost every field of technology.

Furthermore, the problem of the present invention is solved by a use of the device for the production of stretchers, blankets, implants, corsets, support bandages, protectors, seats, halls, signs, items of clothing, transport securing devices, or motor vehicle parts.

The material according to the invention can be made available in an assembly kit, which contains films in the form of a composite in a sterile package. In another embodiment, this device may contain two or more polymers or polymer mixtures according to the invention in the form of a composite or in an assembly kit for the production of a composite. Furthermore, two or more coverings may be in the assembly kit for different purposes. The polymer may already be joined to a covering material or else joined to the covering material only at the site of use. As covering material, it is possible to employ colorless, transparent to opaque materials, or the material is provided with additives that bring about opacity or a certain color. Thus, for example, titanium dioxide can be employed in micronized form in order to create, besides optical opacity, an additional UV protection.

The material according to the invention can be constructed in the form of double covering from a covering material filled with a polymer or polymer mixture. This double covering can be filled with another polymer or polymer mixture, such as, for example, with a gel in the form of a silicone gel or a polyurethane gel, in the form of a viscoelastic foam, or else in the form of a gas, this layer being between 1 mm and 25 cm. During use, a structural change and/or a change in shape is achieved by heating or cooling, for example by way of integrated functions such as conducting additives in the polymer or polymer mixture or heating wires or Peltier elements incorporated therein with an external electrical power supply. Such devices can be employed advantageously for rescuing accident victims. Through the design of the device with temperature-sensitive materials, this device is able to assume both a desired structure and a desired rigidity at the site of use by bringing about an elastification or a rigidification through the supply of heat or cold to cause the temperature to rise above or drop below the glass-transition temperature.

A viscoelastically adjusted material in a covering made of a second material can be modeled around an object to be protected, such as, for example, the spinal column of a person, and solidified by suitable additives and externally supplied energy in such a way that lifting and transport are possible.

Also conceivable is an item of clothing into which the material according to the invention is placed and serves there as a covering. In this case, the item of clothing can be filled in full or in part with the material. Through suitable action of energy from the outside, materials according to the invention that are incorporated into the item of clothing can then solidify or become viscoelastic. In the process, once again through a suitable supply of energy, the temperature drops below the glass-transition temperature (for solidification) or rises above the glass-transition temperature (to produce higher elasticity or softness). The material according to the invention can be designed for the production of helmets, pants, jackets, protective clothing, etc. A special embodiment consists in protective clothing for motorcycle drivers, which consists of a covering made of material such as leather, artificial leather, neoprene, or the like as well as a material incorporated therein, which is capable of absorbing a force, such as, for example, an impulse during an accident, and is made, for example, of a polyurethane or polyether ester according to the invention and thus serves as a protector.

A key area of application of the material according to the invention is medicine and medical technology, including disaster response or rescue services. Fixation bandages or fixation braces can be produced from the material according to the invention.

The combination of a covering material and an energy-absorbing polymer according to the invention results in the creation of a suitable structure. Through the addition of additives that conduct heat and/or electrical energy in the polymer, the bandage material is solidified by absorption or withdrawal of energy, after it is placed on an arm or a leg, so that a permanent, yet reversible support function is achieved. In comparison to the prior art, the material according to the invention offers the advantage that the position of the brace can be corrected at any time, that if can be reused and that the evolution of heat that occurs during hardening of conventional materials does not occur.

Furthermore, the material according to the invention can be used for the production of orthotic devices for the buttocks, the pelvis, the head, and/or the neck of a patient by applying the material in its elastic, deformable state and then putting it into the desired form by means of the fillers incorporated into the polymeric material by absorption or withdrawal of energy. In a similar way, inserts for shoes in the field of orthopedic technology can be produced by creating these inserts from deformable materials, which, above the glass-transition point, are put into the desired form reversibly and, during use, are used in this form. In particular, the material according to the invention is used for structures that, during use, require form correction, such as, for example, in the case of children when the orthotic device has to be worn for a prolonged period of time, which requires a constant adaptation during the growth phase. This effect is achieved through the special characteristics of the materials employed in the devices according to the invention and, through the creation of reversible shaping, in which the material “memorizes” its original shape, can always be reproduced. The possibility of combining different materials according to the invention to form composite substances results in the adjustment of a desired elasticity and hardness, which, during use, can be changed by way of the incorporated additives. The material used as an orthotic device according to the invention is thus markedly easier to produce and to handle and additionally offers the patient the advantage of a millimeter-precise fit and a fit in the requisite hardness. This is possible to only a certain extent with conventional materials, such as thermoformable polymers. The material according to the invention is more flexible due to the ability to achieve a change in its solidity quickly and as often as desired.

Furthermore, it is possible to produce limb prostheses and stump embeddings from the material according to the invention. Achieved in this case are the same advantages as in the case of orthotic devices. A special feature is the use of the material according to the invention as interim prostheses in the case of fresh amputees, for example.

Furthermore, the material according to the invention may be used in accident, tumor, and septic surgery. The material is employed as composite material as an internal or external covering, replacement, or overbridging of tissue defects or tissue damage or in operations. In this case, the material according to the invention is designed in such a way that it can be sterilized and used as an implant. In the process, physiological or pathological changes in body temperature as well as all other physiological and pathological changes in the homeostasis of the organism can also be utilized for targeted and/or intentional changes in state of the polymer or polymer mixture according to the invention, which is employed in the organism.

The material according to the invention may also be used as flat bandaging material, so that, through the combination of a covering material and an energy-absorbing polymer/polymer mixture according to the invention, “intelligent” textiles having a large number of functions are made available, which change their form, their elasticity, and/or their hardness, in particular due to the action of energy. In this case, the material according to the invention can be incorporated once again into an item of clothing, in which, at the same time, sensors and/or sensing elements are incorporated, by means of which the posture and the movements of a patient can be measured and thus monitored. The sensors thereby react to the response of the material to the force and further transmit this in the form of signal, which is produced by transformation of the thermal energy to electrical energy, via the sensors or sensing elements to a measuring device. In this way, it is possible to visualize directly the course of movements, to respond to these movements, and, if need be, to influence them through a change in the polymer/polymer mixture.

In disaster response, the material according to the invention may be used in various forms. One form, for example, is a rescue blanket, which becomes rigid or solid through the use of outside energy, so that injured persons can be transported. In this case, once again, composite substances made of covering materials and the energy-absorbing polymer or polymer mixture according to the invention are used. These polymers or polymer mixtures can be transported to the area of use in rolled form, for example, and unrolled there through use of energy and formed and kept in this form for a certain time by reuse of energy. After the end of use, the original form is reestablished through the shape memory of the polymer by way of energy to be absorbed. This embodiment appreciably simplifies, for example, the complex equipment used in mountain rescue and enables a low-pain to painless support of injured persons to be achieved. Devices produced from the material according to the invention take up less space in motor vehicles or helicopters than previous devices and can be utilized rapidly and efficiently at the site of use.

In the transport sector, the material according to the invention can be employed for the stowing of sensitive objects, including pressure-sensitive objects, during transport by having the material assume the required shape for the objects and by stabilizing this shape with energy supplied or withdrawn from the outside. These embeddings then result in a sustained and efficient protection of the sensitive objects.

In this way, the transport even of bulky objects is made possible by wrapping them with a film made of the material according to the invention, which is subsequently rigidified.

In motor vehicle manufacture, stabilizing seat shells made of the material according to the invention can be produced, in which the energy-absorbing polymer or polymer mixture is positioned beneath the fabric or leather covering of the seats. By means of easily transported additives, there hereby occurs a conduction of energy into the material, with it being possible to couple the energy introduction (the initiator) with the energy supply to the airbag, and the material can assume a different, in this case higher rigidity within a time period of 0.1 to 60 seconds by clearly exceeding the glass-transition point.

This process can be triggered either automatically or else by separate energy to be applied from the outside during rescue use. The deformed material according to the invention in the motor vehicle seat can be removed at an intentional break point by persons outside of the motor vehicle and transported together with the accident victim. In this way, any movements of the accident victim that might lead to further worsening of his or her condition are prevented. Moreover, at any point in time, the shape of the material can be changed by supplying or withdrawing energy and adjusted to changing conditions.

The material according to the invention can also be used in motor vehicle manufacture for the production of convertible roofs. Such a roof, such as the known embodiments made of fabric, would initially be flexible, so that it can easily be opened or closed.

Through actuation of an initiator, which, for example, extends into the material according to the invention via a conductor, it is possible to apply an electrical voltage, which induces the material according to the invention to assume the desired solid shape. In this way, a solid motor vehicle roof would be created that does not have the drawbacks of a fabric roof.

The material according to the invention can also be used to produce tarpaulins for trucks or a tarpaulin for ships, which, in the flexible state, can be stretched out and then subsequently rigidified.

Also a use of the material according to the invention for the production of security systems for bicycles, such as, for example, as a wheel hub security device in connection with a transponder. Rigidification of the material secures the bicycle against unauthorized riding and, if a suitable transponder is used, the material becomes softer once again and enables the bicycle to be used. A lever, such as, for example, the handbrake, can be used as an initiator and the dynamo of the bicycle can be used as energy source.

Similarly, the securing of a bicycle could take place through a flexible or solid bottom bracket.

A use in space technology for solar panels, for example, is also conceivable.

Also conceivable is a use of the material according to the invention in which the material has a double-wall construction, so that it can be employed as inflatable tents or inflatable halls. By means of a design consisting of two shells, which can absorb energy, the shape can be adjusted when the glass-transition point is exceeded and fixed when the temperature drops below the glass-transition point. In this way, the material according to the invention has its own statics in this embodiment, which does not need to be established by way of additional elements. Accordingly, this design makes it possible to create complex structures extremely fast and to utilize their outer walls, for example, for advertising purposes.

Also conceivable, however, is the use of the material according to the invention in other areas of construction. Thus, window shades or blinds and roll-up doors may be produced from the material, which can be rigidified by application of a voltage, for example, and thus also can be connected to a home security/alarm system.

The invention will be described in greater detail below on the basis of figures and examples. The following are shown individually:

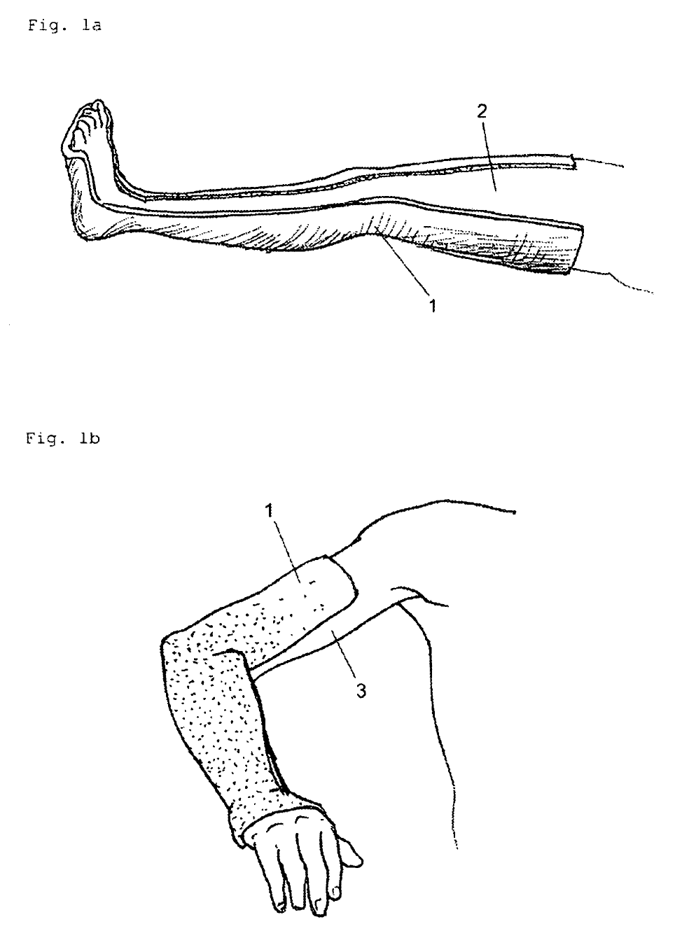

FIG. 1a and b the use of the material according to the invention as a fixation bandage/fixation brace,

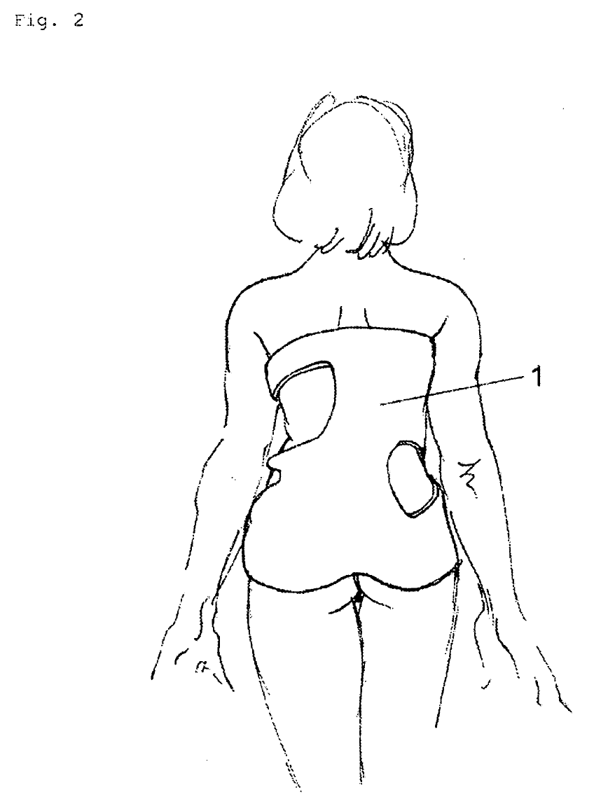

FIG. 2 the use of the material according to the invention as an orthotic device,

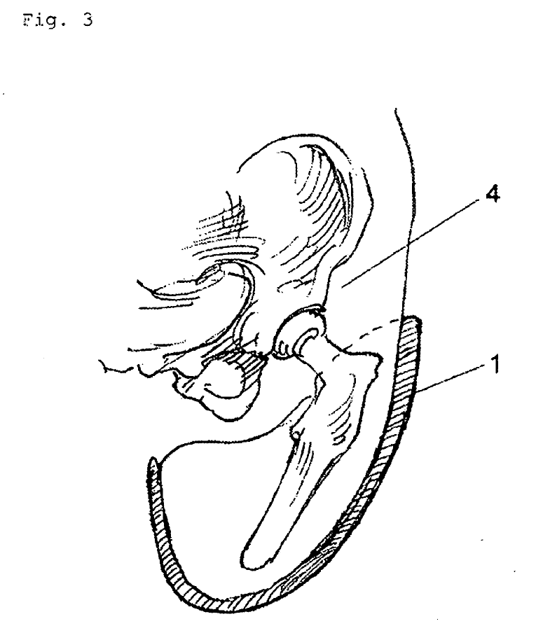

FIG. 3 the use of the material according to the invention as a limb prosthesis,

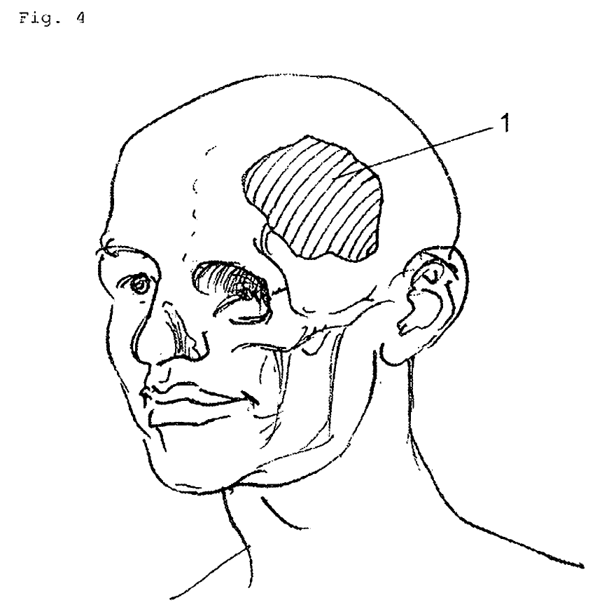

FIG. 4 the use of the material according to the invention as a covering, replacement, and bridging of tissue defects,

FIG. 5 the use of the material according to the invention in textiles,

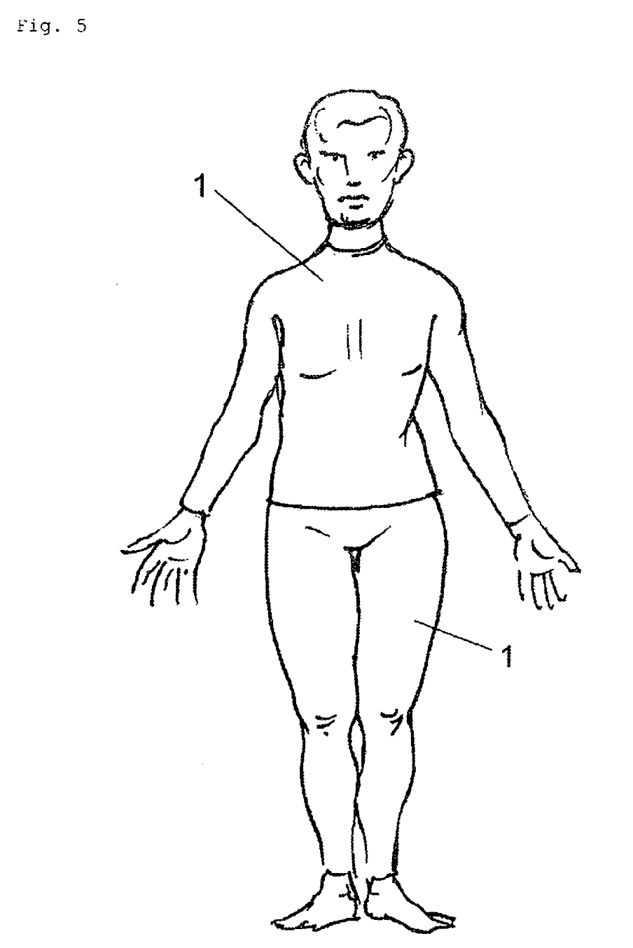

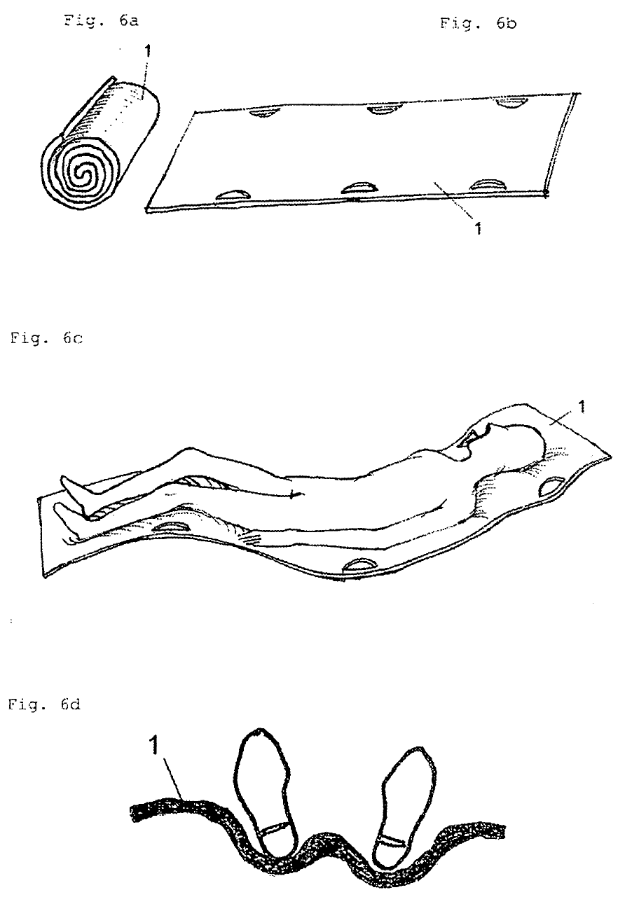

FIG. 6a the use of the material according to the invention as a rescue stretcher (in rolled-up position),

FIG. 6b the use of the material according to the invention as a rescue stretcher (in rolled-out position),

FIG. 6c the use of the material according to the invention as a rescue stretcher (adjusted to a patient),

FIG. 6d the use of the material according to the invention as a rescue stretcher (adjusted to a patient, cross section),

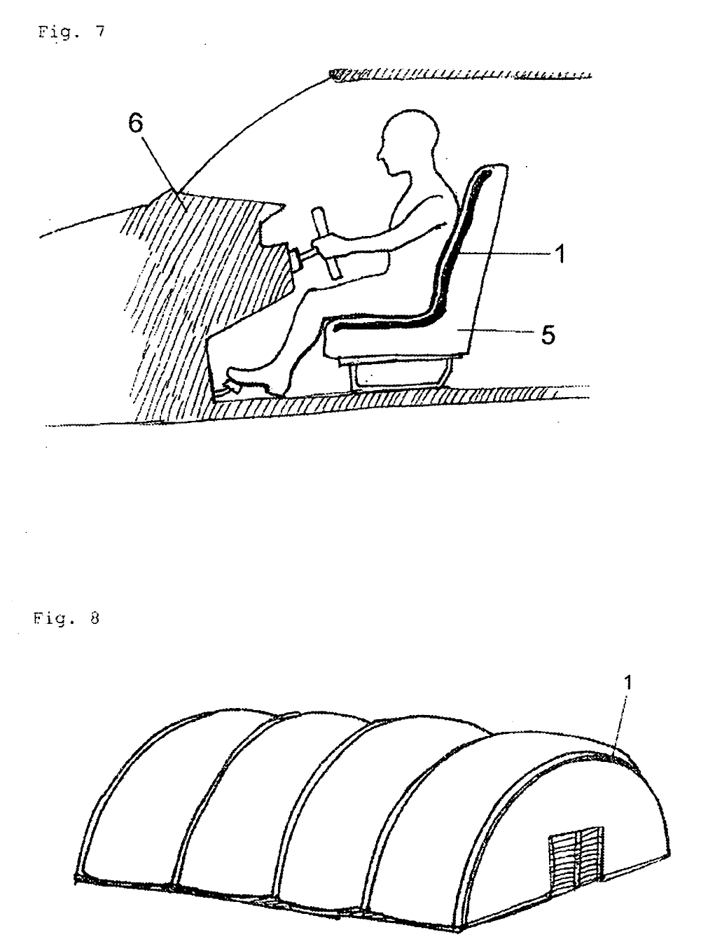

FIG. 7 the use of the material according to the invention as a self-stabilizing seat shell,

FIG. 8 the use of the material according to the invention for the production of a hall,

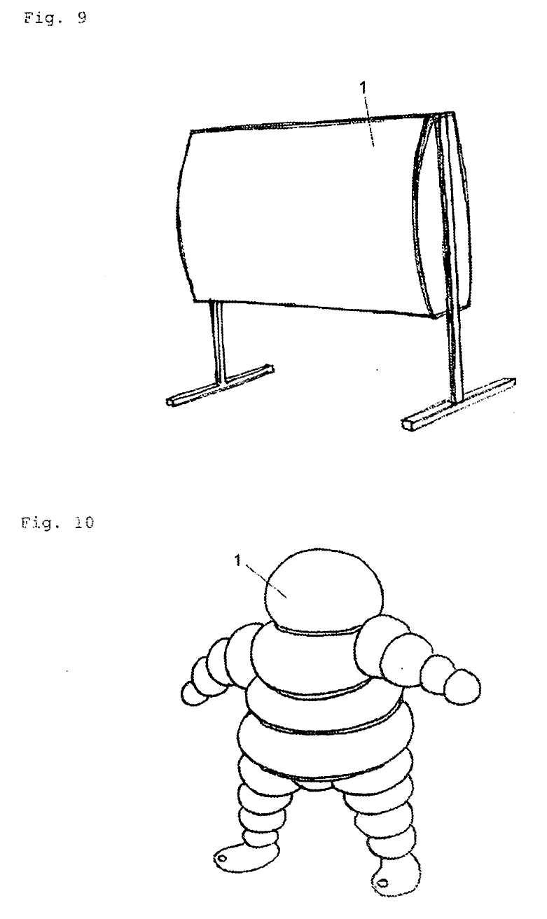

FIG. 9 the use of the material according to the invention for the production of a sign for advertisement, and

FIG. 10 the use of the material according to the invention for the production of a protective suit.

The material 1 according to the invention can be delivered in the form of an assembly kit, which contains the initiator and the polymer and/or the polymer mixture and, if need be, additional fillers. Various polymers and polymer mixtures may be included, so that, depending on the site of use, an appropriate polymer or a polymer mixture can be employed. Different coverings may also be included in the assembly kit. The polymer can already be introduced into the shaping covering or it can be transported separately. The same holds true for the initiator.

The covering can consist of an optically opaque material or a transparent material, so that it is possible to see through the structures produced by the device.

The material 1 according to the invention for the formation of structures can be used for a wide diversity of applications. Thus, it is possible to shape a covering in the form of a stretcher, similar to an air mattress. This can be used for the rescue of accident victims. The polymer or the polymer mixture could be solidified at the site of use and thus create a stable stretcher, making possible a rescue also at inaccessible sites, such as in the mountains, in shafts, or in caves.

Furthermore, it is also possible to use the polymer mixture in a viscous form without a covering in order to model it around a patient lying down in the case of injuries to the spinal column, for example, and then to lift him or her after solidification of the polymer.

Because the solidification can also be triggered by external pressure, it is possible to produce the covering in the form of items of clothing, which are filled with the polymer or the polymer mixture. These items of clothing would then be solidified in full or, if the covering is divided into compartments, solidified in part, thereby affording a protection against the impact of solid objects. In this way, protective clothing, such as helmets, pants, or jackets for motorcycle riders, for example, could be created, which would solidify only through the pressure of the impact.

Also possible are many applications in the field of transport, in which fragile or pressure-sensitive objects can be protected against outside influences by embedding them in the bulk polymer.

These examples illustrate clearly that the material 1 according to the invention has many fields of application. Further applications in the fields of medicine, medical technology, construction, advertisement, the armaments industry, disaster response, motor vehicle manufacture, the food industry, for the construction and the production of pipelines, as shape-development products for negative shapes, and/or for tool manufacture are also conceivable and are discussed below by way of examples.

Branch: Medical Technology

FIGS. 1a and 1b show fixation bandages and fixation braces that are formed by the material 1 according to the invention for the formation of structures. In this embodiment, the covering filled with the polymer or the polymer mixture is placed on the leg 2 or the arm 3 of the patient 8 and then the polymer/polymer mixture is hardened.

In comparison with the plastics that are conventional at the present time, the material according to the invention offers a number of advantages, such as, for example, the fact that it can be corrected at any time, that it can be reused, and that an interfering evolution of heat during hardening of the conventionally used plastics is eliminated.

Branch: Medical technology

FIG. 2 shows the use of the material 1 according to the invention, in which the material 1 is shaped in the form of an orthotic device for the buttocks of a patient. The material 1 assumes here the outer shape of the pelvis and thus creates a structure by means of which the pelvis of the patient is supported.

Branch: Medicine

FIG. 3 shows the use of the device 1 according to the invention as a limb prosthesis/stump bedding.

The flexibility of the device 1 according to the invention offers advantages in the production and fitting of stump beddings, in particular in the case of fresh amputees with interim prostheses.

Branch: Medicine

Another use of the device according to the invention is the use as a covering, a replacement, or an overbridging of tissue defects, as shown in FIG. 4.

The covering of tissue defects in accident, plastic, and septic surgery is undertaken at the present time with metals and so-called bone cement, etc. The device 1 according to the invention can influence the implants in a technically simple corrective manner.

Branch: Medical technology and armaments technology

Illustrated in FIG. 5 is the device 1 according to the invention for use as intelligent and multifunctional textiles.

Present in the clothing, which serves as a covering, is the polymer or the polymer mixture.

Additionally incorporated into the clothing are sensing elements and sensors. The clothing is rigidified by means of an initiator.

Now, the patient can attempt to carry out movements in the respectively desired posture. A measuring result is obtained when the solidified material bends.

The advantage in comparison with old disproportion measuring devices lies in the [low] manufacturing costs and in the simple and fast handling of the two measuring devices.

Another possible use is the utilization of the apparently textile material that can be modeled in various products by dissolving out the soft material, these products then being transformed into a rigid product after triggering the initiator.

For example, keys or hand-weapon-like products would be conceivable. Also, injured persons can simply be transported away, after triggering the initiator, in a type of rigid emergency stretcher that can be created (see also rescue blanket).

Branch: Disaster Response

Another use of the device 1 according to the invention is shown in FIGS. 6a to 6d. Here, the device 1 takes the form of a rescue blanket/rescue cot. Here, too, the shape is imparted by the covering, which is then hardened only [by] solidification of the polymer.

The rescue blanket is brought to the accident victim as a roll. The conventionally rigid design of rescue stretchers or the use of tedious and bulky rescue boats in mountain rescue for the rescue of fallen persons can be simplified and improved by rolling out and shape-modeling the device 1 according to the invention. In this way, the fallen person can be carried in a supported, sustained, and relatively pain-free positioning to the emergency support base.

Further advantages are the easy handling, the small space requirement in emergency vehicles, fast and efficient help in the case of complicated positions through the shape-modeled support, and the elimination of painful movements in preparation for transport.

Branch: Motor Vehicle Manufacture

FIG. 7 shows the use of the device 1 according to the invention as a self-stabilizing seat shell in the motor vehicle seat 5 of a motor vehicle 6.

The initiator for the polymer or of the polymer mixture can be triggered together with the airbag or else be triggered by hand by the rescue team.

The self-triggered or hand-triggered seat shell that has formed from the device 1 according to the invention in a fraction of a second and is located beneath the upper [seat] material, such as fabric or leather, of the motor vehicle seat 5 can then be removed from the motor vehicle seat 5 by the rescue service at an intentional break-away site.

Advantages: The smallest movements can be limited, because the seat shell can be loosened at any time with respect to an emergency escape vacuum jacket and can then be fastened once again in a new position.

Branches: Construction Industry and Advertisement

Illustrated in FIGS. 8, 9, and 10 are further possible uses of the device according to the invention.

Thus, device 1 according to the invention makes possible the production of inflatable tents and inflatable halls, as shown in FIG. 8.

Inflatable tents and inflatable halls [of the prior art] have little weight of their own and can be set up quickly, but, on the other hand, they have the drawbacks that they are susceptible to weather and do not have their own static system capable of withstanding loads.

The use of the device 1 according to the invention enables the positive characteristics to be utilized after triggering the initiator. The negative characteristics are eliminated, because a fabric or rigid and dependable polymers support in a demonstrable manner the shape assumed by the inflatable tents and halls, the advertising units, and other products.

Thus, the device 1 according to the invention allows complicated structures to be created extremely rapidly.

### LIST OF REFERENCE NUMBERS

1. Material for the formation of structures

2. Leg

3. Arm

4. Hip joint

5. Driver's seat

6. Motor vehicle

1. A material for the formation of structures, consisting of a polymer or a polymer mixture and an initiator, with the polymer or the polymer mixture being transformed from a liquid or viscous state to a solid state by activation of the initiator.

2. The material according to claim 1, further characterized in that the change in state of the polymer or the polymer mixture is reversible.

3. The material according to claim 1, further characterized in that the initiator is suitable for transferring energy in the form of heat, force, and/or work to the polymer or the polymer mixture.

4. The material according to claim 1, further characterized in that the polymer is a polyolefin, a polystyrene or a copolymer of polystyrene with acrylonitrile and/or butadiene, a polyurethane, a copolymer of ethane, a polyvinyl alcohol, a polyvinyl butyral, an ethylene-propylene-diene copolymer, a silicone, a polyether or a polyester, or a mixture of these polymers.

5. The material according to claim 1, further characterized in that one or more fillers are included.

6. The material according to claim 5, further characterized in that the filler is a filler selected from the group of electrical conductors, thermally conducting substances, hydrophilic substances, and nanoscale inorganic or organic substances.

7. The material according to claim 1, further characterized in that the polymer or the polymer mixture is enclosed by a covering, wherein the covering provides the shape of the structure.

8. A method for the production of a structure with a material according to claim 1, characterized in that the polymer or the polymer mixture is transformed from a liquid or viscous state to a solid state by activation of the initiator.

9. The method according to claim 8, further characterized in that one or more fillers are incorporated into the polymer or polymer mixture.

10. The method according to claim 8, further characterized in that the filler is selected from the group of electrical conductors, thermally conducting substances, hydrophilic substances, and nanoscale inorganic or organic substances.

11. The method according to claims 8, further characterized in that the polymer or the polymer mixture is introduced into a covering, wherein the covering provides the shape of the structure.

12. The use of the material according to claim 1 for the production of devices having a support function in medicine, in medical technology, in construction, in advertisement, in the armaments industry, in disaster response, in motor vehicle manufacture, in space technology, in the food industry, or in tool production.

13. The use of the material according to claim 1 for the production of stretchers, blankets, implants, corsets, support bandages, protectors, seats, halls, signs, items of clothing, transport securing devices, sports, or motor vehicle parts.
